(19) United States
(12) Patent Application Publication
(10) Pub. No.: US 2011/0156292 A1
(43) Pub. Date: Jun. 30, 2011

(54) METHOD OF MANUFACTURING BRIGHTNESS ENHANCEMENT FILM AND ROLLER USED THEREIN

(75) Inventors: TAI-CHERNG YU, Tu-Cheng (TW); HSIANG-HUNG CHEN, Tu-Cheng (TW)

(73) Assignee: HON HAI PRECISION INDUSTRY CO., LTD., Tu-Cheng (TW)

(21) Appl. No.: 12/814,592

(22) Filed: Jun. 14, 2010

(30) Foreign Application Priority Data
Dec. 24, 2009 (TW) 98144653

(51) Int. Cl. B29D 11/00; B28B 3/12

(52) U.S. Cl. 264/1.6; 425/363

(57) ABSTRACT

A method of manufacturing brightness enhancement film includes a roller with an outer surface and a plurality of micro-structures formed on the outer surface undergoing sandblasting, thereby forming a plurality of rough portions on the outer surface, rolling the blasted roller onto a substrate whereby the micro-structures and the rough portions imprint the substrate to form a plurality of brightness enhancement portions and a plurality of diffusion portions on the outer surface of the blasted roller, and cutting the imprinted substrate to provide a brightness enhancement film.

### BACKGROUND

1. Technical Field

The present disclosure generally relates to a method of manufacturing brightness enhancement film and a roller used in the method.

2. Description of Related Art

Backlight modules are critical components of a liquid crystal display, such as that used in a phone or digital camera. A commonly used backlight module often includes a brightness enhancement film to optimize optical properties. A roll-to-roll process having higher manufacturing efficiency and lower manufacturing cost is often used to manufacture the brightness enhancement film. A roller for embossing or imprinting arrays of structural features, such as a plurality of micro-structures, is rolled and embossed or imprinted on a flexible sheet or film, and in this case is to imprint or emboss a plurality of micro-structures thereon. A new flexible substrate, or film can be rolled for a subsequent imprint, or the rolled flexible sheet or film can be cut to a requisite size and shape. However, such method cannot provide a brightness enhancement film with diffusing function, as is often needed.

Therefore, there is room for improvement within the art.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout several views, and all the views are schematic.

FIG. 1 is an isometric view of a roller.

FIG. 2 is an isometric view of the film of FIG. 1 after undergoing rolling.

FIG. 3 shows the roller of FIG. 2 imprinting a substrate.

FIG. 4 is an isometric view of a brightness enhancement film formed by the roller of FIG. 2.

FIG. 5 is a flowchart of a method of manufacturing brightness enhancement film, performed by a roller such as, for example, that of FIG. 4.

### DETAILED DESCRIPTION

A method of manufacturing brightness enhancement film is described in the following.

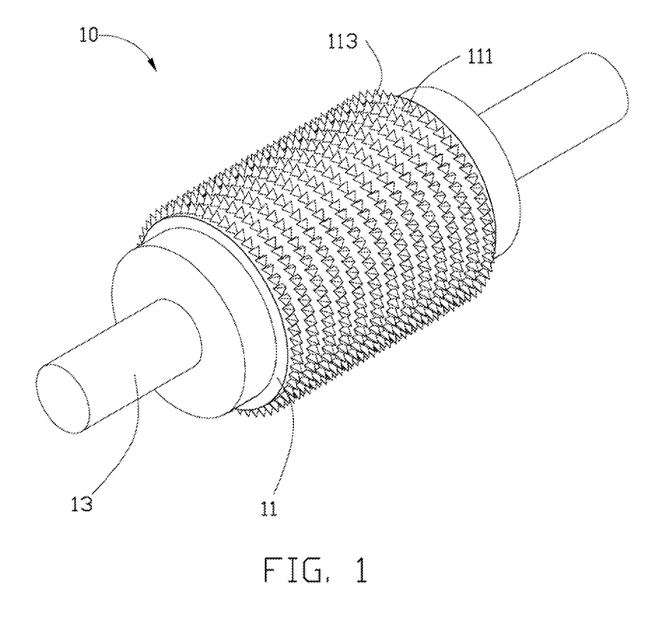

Referring to FIG. 1, a roller 10 is provided. The roller 10 includes a main body 11 and two spindles 13 extending from opposite ends of the main body 11. The main body 11 is a roller and includes an outer surface 111 with a plurality of micro-structures 113 formed on the outer surface 111. The micro-structures 113 may be prisms, cuboids, truncated cones, or other structures. In the illustrated embodiment, the micro-structures 113 are prisms. The micro-structures 113 can be formed by casting, etching, machine cutting, electroplating, or other methods. The micro-structures 113 may be formed on the outer surface 111 directly, or may be alternatively formed on a sheet (not shown) and then adhered to the outer surface 111 of the roller 10.

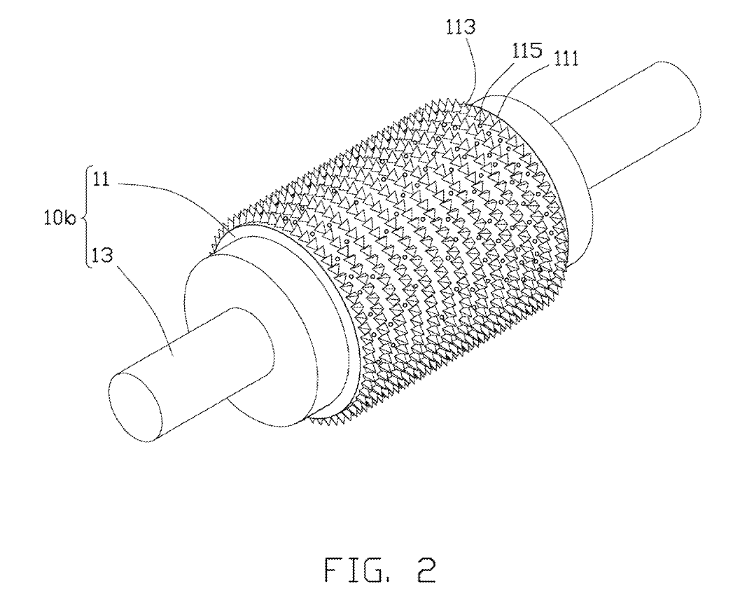

Referring to FIG. 2, a blasted roller 10b is made by using sandblasting device (not shown). A plurality of rough portions 115 are defined in the outer surface 111 by sandblasting performed thereon. The blast speed and pressure of the sandblasting device can be adjusted according to the desired roughness.

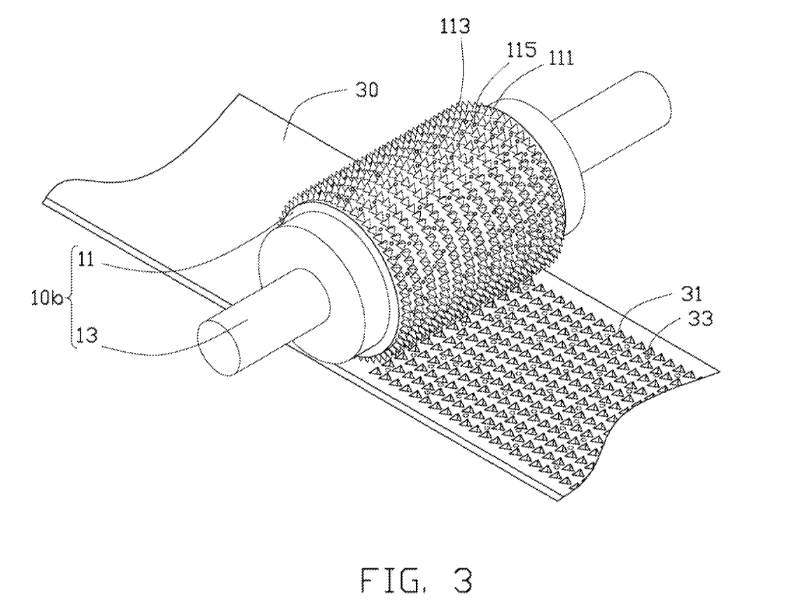

Referring to FIG. 3, a substrate 30 is provided. The substrate 30 may be a film, a flexible sheet, or other flexible material. The substrate 30 can be delivered by an automatic transport device (not shown).

The blasted roller 10b is rolled on and imprinting the substrate 30, whereby the micro-structures 113 form a plurality of brightness enhancement portions 31 and the rough portions 115 form a plurality of diffusion portions 33 on the substrate 30, respectively.

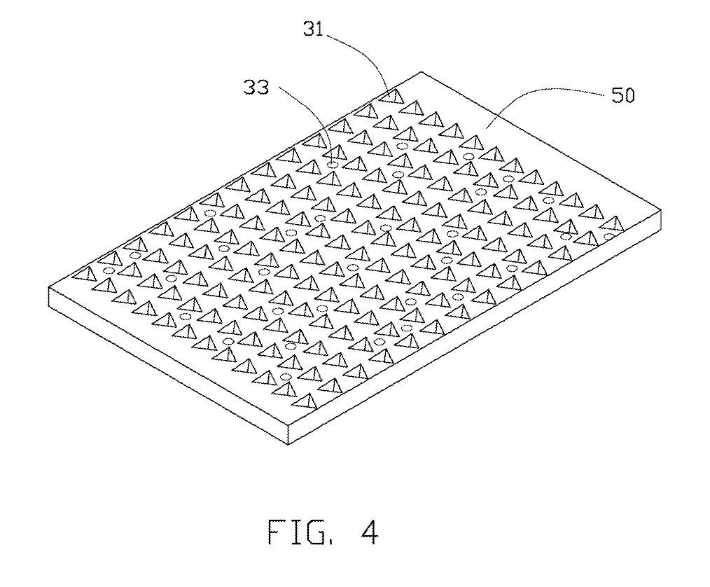

Referring to FIGS. 3 and 4, the substrate 30 with the brightness enhancement portions 31 and the diffusion portions 33 is then cut to achieve the desired dimensions of at least one brightness enhancement film 50.

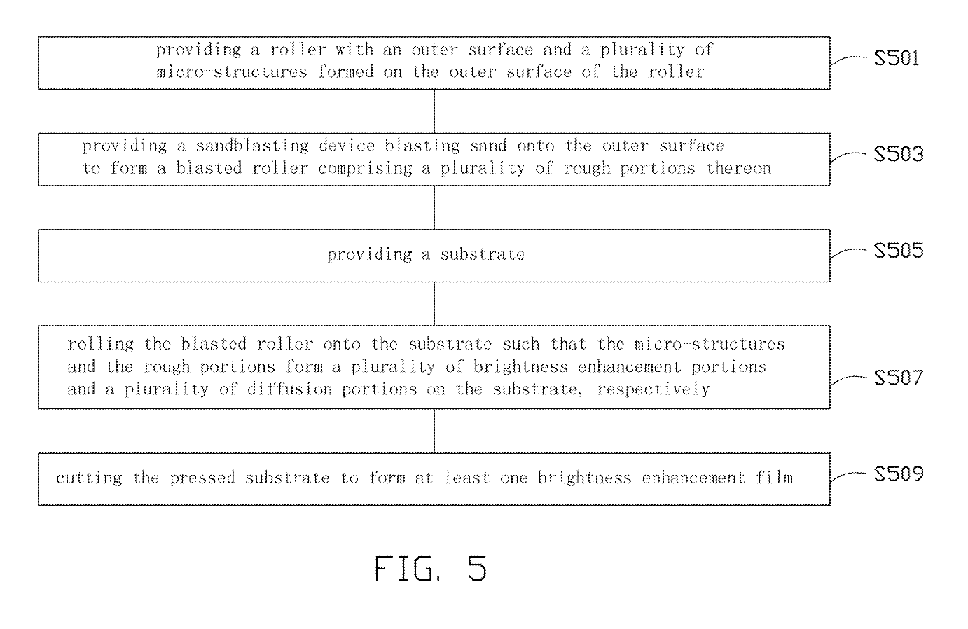

Referring to FIGS. 1 through 5, the method of manufacturing brightness enhancement film is described in the following: S501, providing a roller 10 with an outer surface 111 and a plurality of micro-structures 113 formed on the outer surface 111 of the roller 10; S503, providing a sandblasting device blasting sand onto the outer surface 111 to form a blasted roller 10b comprising a plurality of rough portions 115 thereon; S505, providing a substrate 30; S507, rolling the blasted roller 10b onto the substrate 30 such that the micro-structures 113 and the rough portions 115 form a plurality of brightness enhancement portions 31 and a plurality of diffusion portions 33 on the substrate 30, respectively; S509, cutting the pressed substrate to form at least one brightness enhancement film 50.

The brightness enhancement film 50 produced by the disclosed method includes the brightness enhancement portions 31 and the diffusion portions 33. The brightness enhancement portions 31 gather light, thereby enhancing the brightness of the backlight module. The diffusion portions 33 diffuse light, thereby with no need for requiring additional film. Therefore, the brightness enhancement film 50 provided reduced manufacturing costs. Furthermore, the blasted roller 10b can be used repeatedly, and through the application of further sandblasting procedures, it can be used on various grades of brightness enhancement films having different light diffusion levels.

The manufacturing method of the brightness enhancement film 50 can further include heating the substrate 30 before rolling in order to enhance the embossing effect.

Finally, while various embodiments have been described and illustrated, the disclosure is not to be construed as being limited thereto. Various modifications can be made to the embodiments by those skilled in the art without departing from the true spirit and scope of the disclosure as defined by the appended claims.

What is claimed is:

1. A method of manufacturing a brightness enhancement film, comprising:
providing a roller with an outer surface and a plurality of micro-structures formed on the outer surface of the roller;
providing a sandblasting device blasting sand onto the outer surface to form a blasted roller comprising a plurality of rough portions thereon;
providing a substrate;
rolling the blasted roller onto the substrate such that the micro-structures and the rough portions form a plurality of brightness enhancement portions and a plurality of diffusion portions on the substrate, respectively; and
cutting the pressed substrate to form at least one brightness enhancement film.

2. The method of manufacturing a brightness enhancement film of claim 1 further comprising heating the substrate before the substrate is pressed.

3. The method of manufacturing a brightness enhancement film of claim 1, wherein the micro-structures of the roller are prisms.

4. The method of manufacturing a brightness enhancement film of claim 1, wherein the micro-structures of the roller are formed by casting.

5. The method of manufacturing a brightness enhancement film of claim 1, wherein the micro-structures of the roller are formed by etching.

6. The method of manufacturing a brightness enhancement film of claim 1, wherein the micro-structures of the roller are formed by machine cutting.

7. The method of manufacturing a brightness enhancement film of claim 1, wherein the micro-structures of the roller are formed by electroplating.

8. The method of manufacturing a brightness enhancement film of claim 1, wherein the substrate is a film.

9. The method of manufacturing a brightness enhancement film of claim 1, wherein the substrate is a flexible sheet.

10. A roller, comprising:
an outer surface with a plurality of micro-structures formed thereon;
wherein the outer surface of the roller further comprises a plurality of rough portions formed by sandblasting.

11. The roller of claim 10, wherein the micro-structures of the roller are prisms.

12. The roller of claim 10, wherein the micro-structures of the roller are formed by casting.

13. The roller of claim 10, wherein the micro-structures of the roller are formed by etching.

14. The roller of claim 10, wherein the micro-structures of the roller are formed by machine cutting.

15. The roller of claim 10, wherein the micro-structures of the roller are formed by electroplating.
